(19) United States
(12) Patent Application Publication
(10) Pub. No.: US 2009/0242748 A1
(43) Pub. Date: Oct. 1, 2009

(54) Monopole Time-of-Flight Tandem Mass Spectrometer

(76) Inventor: Gangqiang Li, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/058,770

(22) Filed: Mar. 31, 2008

(51) Int. Cl. B01D 59/44

(52) U.S. Cl. 250/282; 250/286

(57) ABSTRACT

A tandem mass spectrometer operable to determine properties of chemical and biochemical compounds (analytes) comprises an ion source, a monopole ion processing cell positioned to receive primary ions from the ion source and a mass analyzer positioned to receive secondary ions output from the monopole ion processing cell. The monopole ion processing cell comprises an elongate inner electrode and an elongate outer electrode radially offset from and partially surrounding the inner electrode. In one embodiment, the elongate inner and outer electrodes of monopole ion processing cell are segmented, and at least one of the outer electrode segments defines an axial slot through which the secondary ions are radially output to the mass analyzer.

### BACKGROUND

In mass spectrometry, chemical or biochemical compounds (analytes) are ionized in an ion source and the resulting ions are analyzed for their composition according to their mass-to-charge ratio. In a tandem mass spectrometer, a primary mass analyzer, usually a quadrupole ion selector, selects ions of a specific mass-to-charge ratio, and outputs the selected ions to an ion processing cell as primary ions. The ion processing cell confines the primary ions while they undergo such physical or chemical processing as collision-induced dissociation, photo dissociation, electron transfer dissociation, electron-induced dissociation, ion cooling, and ion-ion reactions, to generate secondary ions. The ion processing cell transfers the secondary ions to a secondary mass analyzer for mass analysis. Properties of the analyte are then determined from the mass analysis of the secondary ions.

FIG. 1 shows an example of a conventional tandem mass spectrometer 100 incorporating a quadrupole ion trap as an ion processing cell for determining properties of chemical and biochemical compounds (analytes). The ion processing cell is the part of the tandem mass spectrometer in which selected primary ions obtained from the analyte are confined while they are subject to chemical and/or physical processing that generates secondary ions. The secondary ions are subject to mass analysis in a subsequent stage of the tandem mass spectrometer. Additionally, the ion processing cell operates to confine the secondary ions and to select the ones of the secondary ions for transfer to the second mass analyzer.

The tandem mass spectrometer shown in FIG. 1 is composed of an ion source 102, a primary mass analyzer composed of a quadrupole ion selector 104, a quadrupole ion processing cell 106, and a secondary mass analyzer 108. Ion source 102, the quadrupole ion selector 104, the quadrupole ion processing cell 106 and secondary mass analyzer 108 are arranged following one another along a common axis in the specified order. Ion source 102 is a device that receives the analyte and ionizes the analyte to produce the primary ions that are to be analyzed by the tandem mass spectrometer 100. Examples of processes that ion source 102 may use to ionize the analyte include matrix-assisted laser desorption ionization (MALDI), electrospray ionization (ESI), chemical ionization (CI) and photon ionization (PI).

The quadrupole ion selector 104 is a device that generates a radio frequency (RF) electric field that causes ions of a certain mass-to-charge ratio to pass axially into the quadrupole ion processing cell 106 as primary ions. The quadrupole ion processing cell 106 receives the primary ions from the quadrupole ion selector 104. The operating conditions of the quadrupole ion processing cell 106 are then changed to confine the primary ions within the ion processing cell 106. While confined within the ion processing cell 106, the primary ions undergo chemical and/or physical processing that generates secondary ions from the primary ions. The operating conditions of the quadrupole ion processing cell 106 are then changed once again to transfer the secondary ions in the axial direction into secondary mass analyzer 108. The secondary mass analyzer 108 receives the secondary ions and subjects them to mass analysis. Properties of the analyte are determined from the mass-to-charge ratio of the primary ions output by the quadrupole ion selector 104 and the mass analysis of the secondary ions.

In a conventional tandem mass spectrometer such as that shown in FIG. 1, not all the secondary ions can transfer from the quadrupole ion processing cell 106 to the secondary mass analyzer 108. Since the sensitivity with which the properties of the analyte are determined depends on the number of secondary ions that are subject to mass analysis, the reduced number of secondary ions subject to mass analysis impairs the sensitivity of the determination.

### BRIEF DESCRIPTION OF THE DRAWINGS

FIG. 1 is a block diagram showing an example of a conventional tandem mass spectrometer that incorporates a quadrupole as an ion processing cell.

FIG. 2 is a block diagram showing an example of a tandem mass spectrometer that incorporates a monopole as an ion processing cell in accordance with an embodiment of the invention.

FIG. 3 is a schematic diagram showing an example of a monopole ion processing cell that constitutes part of one embodiment of the tandem mass spectrometer shown in FIG. 2.

FIG. 4 is a schematic diagram showing an example of a monopole ion processing cell with segmented electrodes that constitutes part of another embodiment of the tandem mass spectrometer shown in FIG. 2.

FIG. 5 is a flowchart showing an example of a method in accordance with an embodiment of the invention.

### DETAILED DESCRIPTION

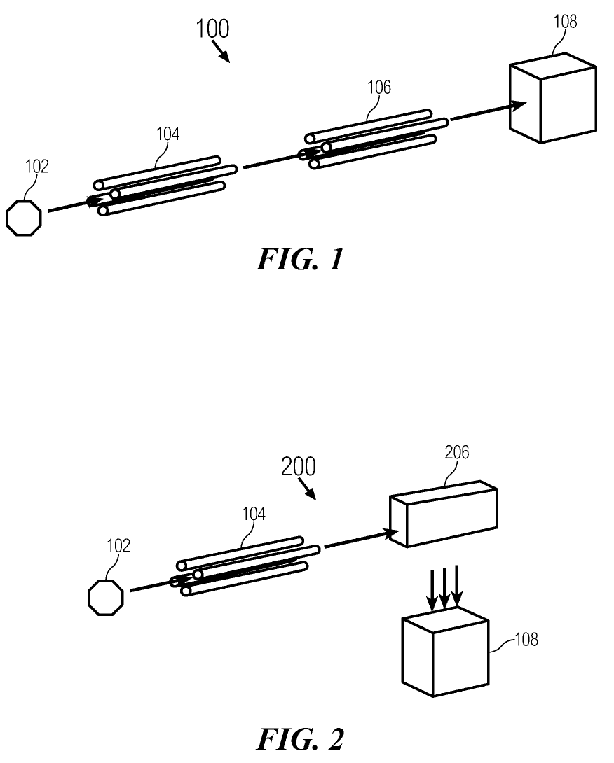

In conventional tandem mass spectrometer 100 described above with reference to FIG. 1, quadrupole ion processing cell 106 and secondary mass analyzer 108 operate at different voltages. The voltage applied to the quadrupole ion processing cell 106 comprises an alternating current (AC) component in the radio frequency (RF) range, while secondary mass analyzer 108 typically operates with a direct current (DC) voltage. The voltage between the AC component on quadrupole ion processing cell 106 and the DC voltage on secondary mass analyzer 108 subjects the secondary ions to a varying electric field. The magnitude and direction of the electric field depends on the amplitude and phase of the AC component. In part of the AC cycle, the electric field subjects the secondary ions to a force that promotes the transfer of the secondary ions into secondary mass analyzer 108 whereas in another part of the AC cycle, the electric field impedes the transfer of the secondary ions. Depending on the magnitude and frequency of the AC component, the fraction of secondary ions successfully transferring from the quadrupole ion processing cell 106 to secondary mass analyzer 108 ranges from about 5% to about 50%, with 20% being the typical number. Embodiments of the invention operate to increase the fraction of secondary ions received by secondary mass analyzer 108.

FIG. 2 is a block diagram showing an example of a tandem mass spectrometer 200 incorporating a monopole ion processing cell in accordance with an embodiment of the invention. Tandem mass spectrometer 200 is composed of ion source 102, a primary mass analyzer, a monopole ion processing cell 206 and secondary mass analyzer 108. In this example, the primary mass analyzer is composed of a quadrupole ion selector 104. Ion source 102, quadrupole ion selector 104 and monopole ion processing cell 206 are arranged in tandem along a common axis in the stated order. The secondary mass analyzer 108 is oriented orthogonally to the common axis and is offset from monopole ion processing cell 206 in a direction orthogonal to the axis.

In the embodiment shown in FIG. 2, ion source 102, quadrupole ion selector 104 and mass analyzer 108 have the same structure and perform the same functions as the corresponding elements indicated by the same reference numerals of the tandem mass spectrometer shown in FIG. 1 and will not be described again here. Monopole ion processing cell 206 operates to receive the primary ions from quadrupole ion selector 104, to confine the primary ions while they undergo chemical and/or physical processing to generate the secondary ions, and to output the secondary ions to the secondary mass analyzer 108. Examples of the processing that the primary ions undergo include collision-induced dissociation, photo dissociation, electron transfer dissociation, electron-induced dissociation, ion recombination and ion cooling.

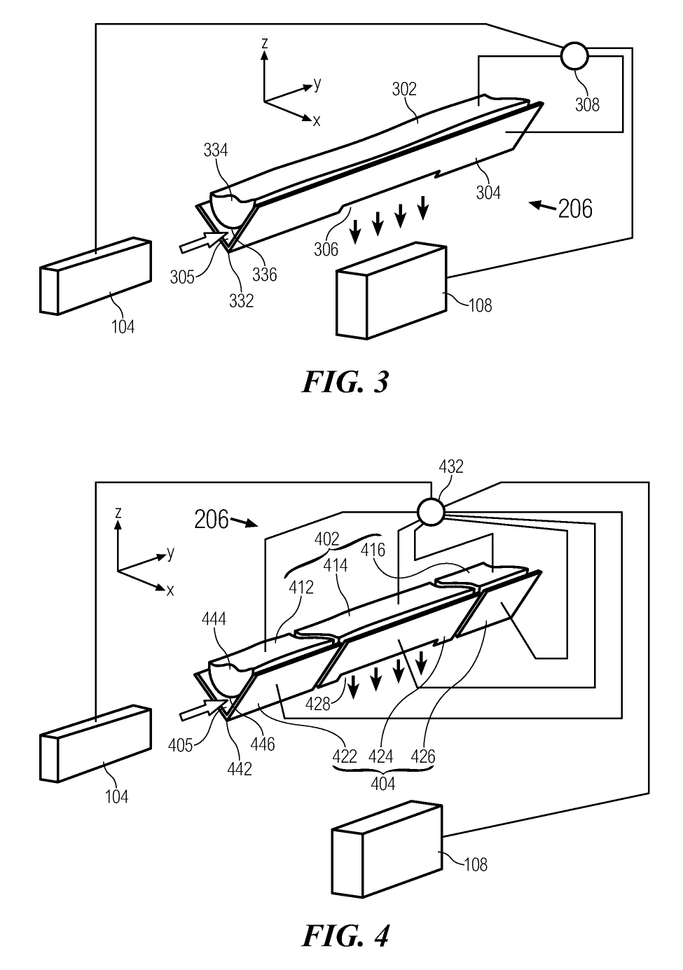

FIG. 3 is a schematic diagram showing an example of monopole ion processing cell 206 used in tandem mass spectrometer 200 in accordance with an embodiment of the invention. Also shown in FIG. 3 is a system of three mutually-orthogonal directions, i.e., an x-direction, a y-direction and a z-direction, that will be used to describe monopole ion processing cell 206. The monopole ion processing cell 206 is composed of an inner electrode 302 and an outer electrode 304. Inner electrode 302 and outer electrode 304 are made of materials that are non-magnetic and are good conductors of electricity. Examples of materials suitable for use in the electrodes are stainless steel, molybdenum, and steel-molybdenum alloys. Alternatively, the inner electrode and the outer electrode are each made of an electrically-insulating core coated with a layer of electrically-conducting material such as gold. Examples of materials suitable for use in the core are glass, quartz and ceramic.

The inner electrode 302 and the outer electrode 304 are each elongate in the y-direction. The outer electrode 304 extends parallel to the inner electrode 302 and is offset from inner electrode 302 in the z-direction to define a confinement space 305 between the outer and inner electrodes. Additionally, in the x-z plane, orthogonal to the y-direction, the outer electrode 304 has a v-shaped cross-sectional shape having an apex 332. Outer electrode 304 defines an axial slot 306 that extends in the y-direction part-way along apex 332. The “v” has an included angle of about 90 degrees, although other angles can be used. The outer electrode partially surrounds the inner electrode 302.

In the x-z plane orthogonal to the y-direction, the inner electrode 302 has cross-sectional shape that includes a hyperbolic portion 334. The hyperbolic portion of the cross-sectional shape has a vertex 336 facing the outer electrode 304. In an example, the vertex 336 of the hyperbolic portion 334 of the cross-sectional shape of the inner electrode faces the apex 332 of the v-shaped cross-sectional shape of the outer electrode.

Also shown in FIG. 3 is a power supply 308. The inner electrode 302 and outer electrode 304 are electrically connected to the output terminals of power supply 308. Power supply 308 additionally has a reference terminal electrically connected to quadrupole ion selector 104 and secondary mass analyzer 108. Power supply 308 operates to apply respective voltages to inner electrode 302 and to outer electrode 304 in the various operational modes of ion processing cell 206. The operational modes of ion processing cell 206 are ion input, ion trap and ion ejection. In each of the operational modes, each of the voltages applied is a direct-current (DC) voltage, an alternating current (AC) voltage having one or more frequency components or a combination of a DC voltage and an AC voltage again having one or more frequency components. Each frequency component of the AC voltage typically has a frequency in the RF range.

In the following examples, the primary ions and the secondary ions are positive ions. In examples in which the primary ions and the secondary ions are negative ions, the polarities of the voltages described below are reversed. In the ion input mode of ion processing cell 206, in one embodiment, power supply 308 applies a first DC voltage between quadrupole ion selector 104 and inner electrode 302, and a second DC voltage between quadrupole ion selector 104 and outer electrode 304. The first DC voltage and the second DC voltage are negative voltages that generate an electric field between quadrupole ion selector 104 and monopole ion processing cell 206. The electric field attracts the primary ions in the y-direction towards and subsequently into the confinement space 305 of monopole ion processing cell 206. In another embodiment, the primary ions output by quadrupole ion selector 104 have sufficient kinetic energy to enter confinement space 305 with no electric field between ion processing cell 206 and quadrupole ion selector 104 to attract the primary ions towards ion processing cell 206. In this embodiment, the first and second DC voltages applied by power supply 308 between quadrupole ion selector 104 and inner electrode 302 and outer electrode 304, respectively, are both zero. In both embodiments, the first DC voltage applied to inner electrode 302 is equal to the second DC voltage applied to outer electrode 304 so that there is no electric field within ion processing cell 206.

After the primary ions have entered confinement space 305, monopole ion processing cell 206 changes to its ion trap mode. In the ion trap mode, power supply 308 applies an AC voltage between inner electrode 302 and outer electrode 304. As noted above, the AC voltage is composed of one or more frequency components. The AC voltage applied between the inner and outer electrodes generates an ion trap electric field in the confinement space 305 between inner electrode 302 and outer electrode 304. The ion trap electric field serves to confine the primary ions within confinement space 305. The ion trap electric field extends radially within the confinement space and varies in amplitude and radial direction in response to the AC voltage. The ion trap electric field interacts with the primary ions that have entered monopole ion processing cell 206 to change their direction of travel from a direction parallel to the y-axis to a direction parallel to the ion trap electric field. Additionally, the AC voltage causes the primary ions to oscillate radially within the confinement space. By causing the primary ions to undergo radial oscillation, the AC voltage effectively confines the primary ions within ion processing cell 206.

While monopole ion processing cell 206 is in the ion trap mode, the primary ions undergo physical and/or chemical reactions to generate secondary ions. Examples of chemical and physical reactions occurring within confinement space 305 are collision-induced dissociation, photo dissociation, electron transfer dissociation, electron-induced dissociation, ion recombination and ion cooling. In some embodiments, an additional ion source (not shown) is positioned to inject additional ions into confinement space 305. The additional ions chemically and/or physically react with the primary ions within confinement space 305 to generate secondary ions by such processes as collision-induced dissociation, photo dissociation, electron transfer dissociation, electron-induced dissociation, ion recombination and ion cooling. The additional ions travel in the y-direction to enter the monopole ion processing cell 206 through the end of monopole ion processing cell 206 remote from quadrupole ion selector 104.

After secondary ions have been generated from the primary ions, monopole ion processing cell 206 changes to its ion ejection mode. In the ion ejection mode, power supply 308 applies a third DC voltage between secondary mass analyzer 108 and inner electrode 302, and a fourth DC voltage, different from the third DC voltage, between secondary mass analyzer 108 and outer electrode 304. The third DC voltage is more positive than the fourth DC voltage. This voltage difference generates an electric field in confinement space 305 that accelerates the secondary ions towards outer electrode 304. The secondary ions travelling towards outer electrode 304 are output from monopole ion processing cell 206 to secondary mass analyzer 108 through axial slot 306.

Typically, the power supply 308 sets the fourth DC voltage to zero so that the outer electrode 304 is at a DC voltage equal to that of secondary mass analyzer 108. With no voltage between outer electrode 304 and secondary mass analyzer 108, there is no potential barrier between the outer electrode and the secondary mass analyzer. Therefore, a larger fraction of the secondary ions generated by monopole ion processing cell 206 reaches secondary mass analyzer 108 for mass analysis. The increased fraction of secondary ions subject to mass analysis improves the sensitivity of determining the properties of the analyte. In one implementation, outer electrode 304 is electrically connected to the reference terminal of power supply 308, and power supply 308 generates only the third DC voltage that is applied to inner electrode 304.

Alternatively, power supply 308 sets the fourth DC voltage to a voltage greater than zero and sets the third DC voltage to a voltage greater than the fourth DC voltage. The fourth DC voltage applied between outer electrode 304 and secondary mass analyzer 108 generates an electric field that accelerates the secondary ions radially output from monopole ion processing cell 206 through axial slot 306 towards secondary mass analyzer 108.

FIG. 4 is a schematic diagram showing another example of monopole ion processing cell 206 used in tandem mass spectrometer 200 in accordance with an embodiment of the invention. In this embodiment, the inner electrode and the outer electrode are each segmented lengthways to create inner electrode segments and outer electrode segments, respectively. The inner and outer electrode segments allow a voltage pattern to be applied to the electrodes to create a three-dimensional potential well in monopole ion processing cell 206. The three-dimensional potential well provides greater control over the input, confinement and output of ions by monopole ion processing cell 206. In the example shown in FIG. 4, the three-dimensional potential well confines the ions axially and radially within the confinement space of monopole ion processing cell 206.

The example of monopole ion processing cell 206 shown in FIG. 4 is composed of an inner electrode 402 and an outer electrode 404. Outer electrode 404 partially surrounds inner electrode 402. Outer electrode 404 extends parallel to inner electrode 402 and is offset from inner electrode 402 in the z-direction to define a confinement space 405 between the outer and inner electrodes. Inner electrode 402 is composed of inner electrode segments 412, 414 and 416 arranged in tandem in the y-direction. Each of the inner electrode segments 412, 414 and 416 is elongate in the y-direction. Outer electrode 404 is composed of outer electrode segments 422, 424 and 426. Each of the outer electrode segments 422, 424 and 426 is elongate in the y-direction. Outer electrode segments 422, 424 and 426 are disposed opposite inner electrode segments 412, 414 and 416, respectively. The inner and outer electrode segments are made of materials that are non-magnetic and are good conductors of electricity. Examples of materials suitable for use in the electrode segments are stainless steel, molybdenum and steel-molybdenum alloys. Alternatively, either or both of the inner electrode segments and the outer electrode segments are each made of an electrically-insulating core that is coated with a layer of electrically-conducting material such as gold. Examples of materials suitable for use in the core are glass, quartz and ceramic.

In the x-z plane, orthogonal to the y-direction, each of the outer electrode segments 422, 424 and 426 has a v-shaped cross-sectional shape having an apex 442. The “v” has an included angle of about 90 degrees, although other angles can be used.

In the x-z plane, each of the inner electrode segments 412, 414 and 416 has a cross-sectional shape that includes a hyperbolic portion 444. The hyperbolic portion of the cross-sectional shape has a vertex 446 facing the outer electrode 404. In an example, the vertex 446 of the hyperbolic portion 444 of the cross-sectional shape of the inner electrode segments faces the apex 442 of the v-shaped cross-sectional shape of the outer electrode segments. At least one of the outer electrode segments 422, 424 and 426 defines an axial slot 428 that extends in the y-direction part-way along the apex 442 of the v-shaped cross-sectional shape of the respective outer electrode segment. In the example shown in FIG. 4, axial slot 428 extends along only part of the length of outer electrode segment 424, located between outer electrode segments 422 and 426. In another example, axial slot 428 extends along the full length of outer electrode segment 424. In another example, axial slot 428 extends along the full length of outer electrode segment 424 and additionally extends part-way into neighboring outer electrode segments 422 and 426.

Also shown in FIG. 4 is a power supply 432. Inner electrode segments 412, 414 and 416 and outer electrode segments 422, 424 and 426 are electrically connected to the output terminals of power supply 432. Power supply 432 additionally has a reference terminal electrically connected to quadrupole ion selector 104 and secondary mass analyzer 108. Power supply 432 operates to apply respective voltages to inner electrode segments 412, 414 and 416 and to outer electrode segments 422, 424 and 426 in the various operational modes of ion processing cell 206. The operational modes of ion processing cell 206 are ion input, ion trap and ion ejection. In each of the operational modes, each of the voltages applied is a direct-current (DC) voltage, an alternating current (AC) voltage having one or more frequency components or a combination of a DC voltage and an AC voltage again having one or more frequency components. Each frequency component of the AC voltage typically has a frequency in the RF range. In one embodiment, power supply 432 is composed of a computer and an output module connected to each of the electrode segments. The computer operates to control and coordinate the supply of voltages by the output modules to the electrode segments.

In the following examples, the primary ions and the secondary ions are positive ions. In examples in which the primary ions and the secondary ions are negative ions, the polarities of the voltages described below are reversed. In the ion input mode, power supply 432 applies a first DC voltage between quadrupole ion selector 104 and each of the inner electrode segments 412 and 414, and applies a second DC voltage between quadrupole ion selector 104 and inner electrode segment 416. Additionally, power supply 432 applies a third DC voltage between quadrupole ion selector 104 and each of the outer electrode segments 422 and 424 and applies a fourth DC voltage between quadrupole ion selector 104 and outer electrode segment 426. The first DC voltage and the third DC voltage are negative voltages that generate an electric field between quadrupole ion selector 104 and monopole ion processing cell 206. The electric field attracts the primary ions from quadrupole ion selector 104 in the y-direction towards and subsequently into the confinement space 405 of monopole ion processing cell 206. The second DC voltage is a negative voltage with a magnitude less than that of the first DC voltage to make the DC voltage on inner electrode segment 416 more positive than the DC voltage on the inner electrode segments 412 and 414. Also, the fourth DC voltage is a negative voltage with a magnitude less than that of the third DC voltage to make the DC voltage on outer electrode segment 426 more positive than the DC voltage on the outer electrode segments 422 and 424. The more-positive DC voltages on inner electrode segment 416 and outer electrode segment 426 create a potential barrier in the portion of confinement space 405 bounded by inner electrode segment 416 and outer electrode segment 426. The potential barrier stops the primary ions from exiting monopole ion processing cell 206 through the end of the monopole ion processing cell remote from quadrupole ion selector 104.

In another embodiment, the primary ions output by quadrupole ion selector 104 have sufficient kinetic energy to enter confinement space 405 with no electric field between quadrupole ion selector 104 and monopole ion processing cell 206. In this embodiment, the first DC voltage applied by power supply 432 between quadrupole ion selector 104 and inner electrode segments 412 and 414 and the third DC voltage between quadrupole ion selector 104 and outer electrode segments 422 and 424 respectively, are both zero. In this embodiment, the second DC voltage between quadrupole ion selector 104 and inner electrode segment 416, and the fourth DC voltage between quadrupole ion selector 104 and outer electrode segment 426 are positive voltages that create a potential barrier in the portion of confinement space 405 bounded by inner electrode segment 416 and outer electrode segment 426. The potential barrier stops the primary ions from exiting monopole ion processing cell 206 through the end of the monopole ion processing cell remote from quadrupole ion selector 104.

In both of the above-described embodiments, the first DC voltage applied to inner electrode segments 412 and 414 is equal to the third DC voltage applied to outer electrode segments 422 and 424, and the second DC voltage applied to inner electrode segment 416 is equal to the fourth DC voltage applied to outer electrode segment 426 so that there is no radial electric field within ion processing cell 206.

After the primary ions have entered confinement space 405, monopole ion processing cell 206 changes to its ion trap mode. In one embodiment, power supply 432 applies an AC voltage between inner electrode segment 414 and outer electrode segment 424. As noted above, the AC voltage is composed of one or more frequency components. The AC voltage applied between inner electrode segment 414 and outer electrode segment 424 generates an ion trap electric field in confinement space 405. The ion trap electric field extends radially within the confinement space and varies in amplitude and radial direction in response to the AC voltage. The ion trap electric field interacts with the primary ions that have entered monopole ion processing cell 206 to change their direction of travel from a direction parallel to the y-axis to a direction parallel to the ion trap electric field. Additionally, the AC voltage causes the primary ions to oscillate radially within the confinement space. Power supply 432 additionally applies a fifth DC voltage to each of inner electrode segments 412 and 416, a sixth DC voltage to inner electrode segment 414, a seventh DC voltage to each of outer electrode segments 422 and 426 and an eighth DC voltage to outer electrode segment 424. The sixth DC voltage and eighth DC voltage are respectively less positive than the fifth DC voltage and the seventh DC voltage to create an axial potential barrier adjacent each end of monopole ion processing cell 206. The potential barriers prevent the primary ions from exiting monopole ion processing cell 206 through its ends. By preventing the primary ions from exiting monopole ion processing cell 206 both axially through either end and radially, the fifth, sixth, seventh and eighth DC voltages and the AC voltage collectively and effectively confine the primary ions within ion processing cell 206. The seventh DC voltage is typically equal to the fifth DC voltage and the eighth DC voltage is typically equal to the sixth DC voltage so that there is no radial DC electric field in monopole ion processing cell 206. Moreover, either the fifth DC voltage or the sixth DC voltage is typically zero.

While monopole ion processing cell 206 is in the ion trap mode, the primary ions undergo physical and/or chemical reactions to generate secondary ions. Once generated, the secondary ions remain confined within confinement space 405 by the fifth, sixth, seventh and eighth DC voltages and the AC voltage applied to the various electrode segments. Examples of chemical and physical reactions occurring in confinement space 405 are collision-induced dissociation, photo dissociation, electron transfer dissociation, electron-induced dissociation, ion recombination and ion cooling. In some embodiments, an additional ion source (not shown) is positioned to inject additional ions into confinement space 405. The additional ions chemically and/or physically react with the primary ions within confinement space 405 to generate secondary ions by such processes as collision-induced dissociation, photo dissociation, electron transfer dissociation, electron-induced dissociation, ion recombination and ion cooling. The additional ion source is positioned such that the additional ions travel in the y-direction to enter the monopole ion processing cell 206 through the end of monopole ion processing cell 206 remote from quadrupole ion selector 104.

After secondary ions have been generated from the primary ions, monopole ion processing cell 206 changes to its ion ejection mode. In the ion ejection mode, power supply 432 changes either or both of the sixth DC voltage applied to inner electrode segment 414 and the eighth DC voltage applied to outer electrode segment 424 to make the sixth DC voltage more positive than the eighth DC voltage. The difference between the sixth DC voltage and eighth DC voltage generates a radial electric field in confinement space 405. The electric field accelerates the secondary ions towards outer electrode segment 424. The secondary ions travelling towards outer electrode segment 424 are output from monopole ion processing cell 206 to secondary mass analyzer 108 through axial slot 428. Additionally, power supply 432 changes the fifth DC voltage applied to inner electrode segments 412 and 416 to make it more positive than the sixth DC voltage applied to inner electrode segment 414, and changes the seventh DC voltage applied to outer electrode segments 422 and 426 to make it more positive than the eighth DC voltage applied to outer electrode segment 424. Changing the fifth and seventh DC voltages maintains the axial potential barrier adjacent each end of monopole ion processing cell 206. The potential barriers prevent the secondary ions and the remaining primary ions from exiting monopole ion processing cell 206 through its ends. By preventing the primary and secondary ions from exiting monopole ion processing cell 206 both axially through either end and radially, the fifth, sixth, seven and eighth DC voltages and AC voltage collectively and effectively confine the primary and secondary ions within ion processing cell 206 in the ion ejection mode.

Typically, power supply 432 sets the eighth DC voltage to zero so that the outer electrode segment 424 is at a DC voltage equal to that of secondary mass analyzer 108. With no voltage between outer electrode segment 424 and secondary mass analyzer 108, there is no potential barrier between outer electrode segment 424 and the secondary mass analyzer. Therefore, a larger fraction of the secondary ions generated by monopole ion processing cell 206 reaches secondary mass analyzer 108 for mass analysis. The increased fraction of secondary ions subject to mass analysis improves the sensitivity of determining the properties of the analyte. In one implementation, outer electrode segment 424 is electrically connected to the reference terminal of power supply 432, and power supply 432 generates no eighth DC voltage.

Alternatively, power supply 432 sets the eighth DC voltage to a voltage greater than zero, the sixth DC voltage to a voltage greater than the eighth DC voltage, and the fifth and seventh DC voltages to voltages greater than the sixth and eighth DC voltages, respectively. The eighth DC voltage applied between outer electrode segment 424 and secondary mass analyzer 108 generates an electric field that accelerates the secondary ions radially output from monopole ion processing cell 206 through axial slot 428 towards secondary mass analyzer 108.

Although FIG. 4 shows an example of monopole ion processing cell 206 that is composed of three inner electrode segments and three outer electrode segments, embodiments of the invention are not limited to a monopole ion processing cell having the number of electrode segments illustrated in FIG. 4. Embodiments of the invention can have a monopole ion processing cell having other numbers of electrode segments, including embodiments having an unequal number of outer electrode segments and inner electrode segments.

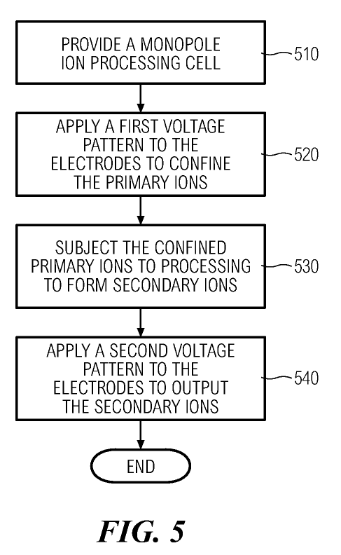

FIG. 5 is a flowchart showing an example of a method in accordance with an embodiment of the invention. In block 510, a monopole ion processing cell is provided. The monopole ion processing cell comprises an elongate inner electrode and an elongate outer electrode. The inner electrode is radially offset from, and partially surrounds, the inner electrode. In one embodiment, the monopole ion processing cell described above with reference to FIG. 3 is provided. In another embodiment, the monopole ion processing cell described above with reference to FIG. 4 is provided.

In block 520, a first voltage pattern is applied to the electrodes of the monopole ion processing cell to confine the primary ions within the ion processing cell.

In block 530, the primary ions confined within the monopole ion processing cell are subject to processing that generates secondary ions by modifying the primary ions at least one of physically and chemically.

In block 540, a second voltage pattern is applied to the electrodes to output the secondary ions from the monopole ion processing cell for mass analysis.

In one embodiment, in block 520, the first voltage pattern creates a potential well that is bounded by a potential barrier. The potential barrier operates to confine the primary ions within the potential well. In another embodiment, the first voltage pattern is modified to lower part of the potential barrier to admit the primary ions into the monopole ion processing cell.

In various embodiments, in block 530, the processing involves at least one of collision-induced dissociation, photo dissociation, electron transfer dissociation, charge transformation, ion recombination and ion cooling.

In one embodiment, in block 540, the second voltage pattern applied to the electrodes generates an electric field that ejects the secondary ions from the monopole ion processing cell in an axial direction, i.e., in a direction parallel to the direction in which the electrodes are elongate. In the embodiment, the second voltage pattern is applied to the electrodes of the monopole ion processing cell described above with reference to FIG. 4. In the following example, the primary ions and the secondary ions are positive ions. In examples in which the primary ions and the secondary ions are negative ions, the polarities of the voltages described below are reversed. In the monopole ion processing cell, power supply 432 applies a ninth DC voltage between secondary mass analyzer 108 and each of inner electrode segment 412 and outer electrode segment 422, a tenth DC voltage between secondary mass analyzer 108 and each of inner electrode segment 414 and outer electrode segment 424, and an eleventh DC voltage between secondary mass analyzer 108 and each of inner electrode segment 416 and outer electrode segment 426. The equal DC voltages on the inner electrode segment and the corresponding outer electrode segment ensures that there is no radial electric field acting on the secondary ions in the confinement space between the inner and outer electrode segment. In one embodiment of the monopole processing cell, the eleventh DC voltage is less positive than the tenth DC voltage, which is itself less positive than the ninth DC voltage. The difference in the DC voltages on the electrode segments creates an electric field acting axially in the direction of inner electrode segment 416 and outer electrode segment 426. The axial electric field ejects the secondary ions axially out of the monopole ion processing cell. To maximize the transfer of secondary ions from monopole ion processing cell 206 to mass analyzer 108, the eleventh DC voltage is a positive voltage. In another example, the eleventh DC voltage is zero.

In another embodiment, in block 510, the outer electrode defines an elongate axial slot, and, in block 540, the second voltage pattern applied to the electrodes generates an electric field that ejects the secondary ions from the monopole ion processing cell in a radial direction, i.e., in a direction orthogonal to the axial direction. In one embodiment, the secondary ions are ejected in a radial direction from the monopole ion processing cell described above with reference to FIG. 3. In this embodiment, power supply 308 applies the third DC voltage between secondary mass analyzer 108 and inner electrode 302, and the fourth DC voltage, different from the third DC voltage, between secondary mass analyzer 108 and outer electrode 304. The third DC voltage is more positive than the fourth DC voltage. This voltage difference generates a radial electric field in confinement space 305 that accelerates the secondary ions towards outer electrode 304. The secondary ions travelling towards outer electrode 304 are output from monopole ion processing cell 206 to secondary mass analyzer 108 through axial slot 306. Typically, the power supply 308 sets the fourth DC voltage to zero so that the outer electrode 304 is at a DC voltage equal to that of secondary mass analyzer 108. With no voltage between outer electrode 304 and secondary mass analyzer 108, there is no potential barrier between the outer electrode and the secondary mass analyzer. Therefore, a larger fraction of the secondary ions generated by monopole ion processing cell 206 reaches secondary mass analyzer 108 for mass analysis. Alternatively, power supply 308 sets the fourth DC voltage to a positive voltage to generate between the outer electrode 304 and secondary mass analyzer 108 an electric field that accelerates the secondary ions towards the secondary mass analyzer.

In another embodiment, the secondary ions are ejected in a radial direction from the monopole ion processing cell described above with reference to FIG. 4. In this embodiment, power supply 432 changes either or both of the sixth DC voltage applied to inner electrode segment 414 and the eighth DC voltage applied to outer electrode segment 424 to make the sixth DC voltage more positive than the eighth DC voltage. The difference between the sixth DC voltage and eighth DC voltage generates a radial electric field in confinement space 405. The electric field accelerates the secondary ions towards outer electrode segment 424. The secondary ions travelling towards outer electrode segment 424 are output from monopole ion processing cell 206 to secondary mass analyzer 108 through axial slot 428. Additionally, power supply 432 changes the fifth DC voltage applied to inner electrode segments 412 and 416 to make it more positive than the sixth DC voltage applied to inner electrode segment 414, and changes the seventh DC voltage applied to outer electrode segments 422 and 426 to make it more positive than the eighth DC voltage applied to outer electrode segment 424. Changing the fifth and seventh DC voltages maintains the axial potential barrier adjacent each end of monopole ion processing cell 206. The potential barriers prevent the secondary ions and the remaining primary ions from exiting monopole ion processing cell 206 through its ends. By preventing the primary and secondary ions from exiting monopole ion processing cell 206 both axially through either end and radially, the fifth, sixth, seven and eighth DC voltages and AC voltage collectively and effectively confine the primary and secondary ions within ion processing cell 206 in the ion ejection mode. Typically, power supply 432 sets the eighth DC voltage to zero so that the outer electrode segment 424 is at a DC voltage equal to that of secondary mass analyzer 108. With no voltage between outer electrode segment 424 and secondary mass analyzer 108, there is no potential barrier between outer electrode segment 424 and the secondary mass analyzer. Therefore, a larger fraction of the secondary ions generated by monopole ion processing cell 206 reaches secondary mass analyzer 108 for mass analysis. Alternatively, power supply 432 sets the eighth DC voltage to a positive voltage to generate between outer electrode segment 424 and secondary mass analyzer 108 an electric field that accelerates the secondary ions towards the secondary mass analyzer.

This disclosure describes the invention in detail using illustrative embodiments. However, the invention defined by the appended claims is not limited to the precise embodiments described.

I claim:

1. A tandem mass spectrometer, comprising:
an ion source;
a monopole ion processing cell positioned to receive primary ions from the ion source, the processing cell comprising:
an elongate inner electrode; and
an elongate outer electrode radially offset from and partially surrounding
the inner electrode, the outer electrode defining an axial slot; and
a mass analyzer positioned to receive secondary ions output from the axial slot.

2. The tandem mass spectrometer of claim 1, in which the ion source comprises:
a source of ions; and
a quadrupole ion selector arranged to receive ions from the source of ions and operable to provide selected ones of the ions to the ion processing cell as the primary ions.

3. The tandem mass spectrometer of claim 1, in which the outer electrode has a v-shaped cross-sectional shape in a plane orthogonal to a length direction thereof.

4. The tandem mass spectrometer of claim 3, in which the inner electrode has a cross-sectional shape in a plane orthogonal to a length direction thereof, the cross-sectional shape comprising a hyperbolic portion having a vertex facing towards the outer electrode.

5. The tandem mass spectrometer of claim 3, in which:
the v-shaped cross-sectional shape of the outer electrode has an apex; and
the axial slot extends part way along the apex of the outer electrode.

6. The tandem mass spectrometer of claim 1, in which the outer electrode is electrically connected to the mass analyzer.

7. The tandem mass spectrometer of claim 1, additionally comprising a power supply electrically connected to the inner electrode and the outer electrode, the power supply operable to generate an first voltage pattern to confine the primary ions within the ion processing cell and to generate a second voltage pattern to output the secondary ions from the ion processing cell to the mass analyzer via the slot.

8. The tandem mass spectrometer of claim 1, in which at least one of the inner electrode and the outer electrode comprises electrode segments arranged in tandem.

9. The tandem mass spectrometer of claim 8, additionally comprising a power supply electrically connected to the inner electrode and the outer electrode, the power supply operable to apply different voltage patterns to the electrode segments during receipt of the primary ions from the ion source, confinement of the primary ions within the ion processing cell and output of the secondary ions from the ion processing cell to the mass analyzer via the axial slot.

10. A tandem mass spectrometer, comprising:
an ion source;
a monopole ion processing cell positioned to receive primary ions from the ion source, the processing cell comprising:
an elongate inner electrode comprising inner electrode segments arranged in tandem; and
an elongate outer electrode radially offset from and partially surrounding the inner electrode, the outer electrode comprising outer electrode segments disposed opposite respective ones of the inner electrode segments, at least one of the outer electrode segments defining an axial slot; and
a mass analyzer positioned to receive secondary ions radially output through the slot.

11. The tandem mass spectrometer of claim 10, in which the ion source comprises:
a source of ions; and
a quadrupole ion selector arranged to receive ions from the source of ions and to provide selected ones of the ions to the ion processing cell as the primary ions.

12. The tandem mass spectrometer of claim 10, in which:
the outer electrode and the inner electrode define a confinement space between them; and
the tandem mass spectrometer additionally comprises a power supply electrically connected to the inner electrode and the outer electrode, and operable to apply to the electrode segments a voltage pattern that establishes a potential well in the confinement space.

13. The tandem mass spectrometer of claim 12, in which the voltage pattern comprises an AC component.

14. The tandem mass spectrometer of claim 12, in which the power supply is additionally operable to apply to the electrode segments an additional voltage pattern that causes the secondary ions to be output radially through the axial slot to the mass analyzer.

15. A method, comprising:
providing a monopole ion processing cell comprising:
an elongate inner electrode; and
an elongate outer electrode radially offset from and partially surrounding the inner electrode; and
applying a first voltage pattern to the electrodes to confine primary ions within the ion processing cell;
subjecting the confined primary ions to processing that generates secondary ions by modifying the primary ions at least one of physically and chemically; and
applying a second voltage pattern to the electrodes to output the secondary ions for mass analysis.

16. The method of claim 15, in which:
the outer electrode defines an axial slot; and
applying the second voltage pattern outputs the secondary ions radially through the axial slot.

17. The method of claim 15, in which applying the second voltage pattern outputs the secondary ions axially.

18. The method of claim 15, in which:
the inner electrode comprises inner electrode segments arranged in tandem;
the outer electrode comprises outer electrode segments disposed opposite the inner electrode segments; and
applying the first voltage pattern comprises applying to the electrode segments a voltage pattern that establishes a potential well.

19. The method of claim 18, in which:
the potential well is surrounded by a potential barrier;
the method additionally comprises receiving the primary ions in the processing cell, the primary ions travelling in an axial direction; and
the receiving comprises modifying the first voltage pattern to lower part of the potential barrier.

20. The method of claim 15, in which the processing comprises one of collision-induced dissociation, photo dissociation, electron transfer dissociation, electron-induced dissociation, ion recombination and ion cooling.
